(19) United States
(12) Patent Application Publication
(10) Pub. No.: US 2011/0297237 A1
(43) Pub. Date: Dec. 8, 2011

(54) Apparatus For Emergency Electrodynamic Capping Of Pipes And Wells

(76) Inventor: Dieter Wolfgang Blum, Aldergrove (CA)

(21) Appl. No.: 13/152,250

(22) Filed: Jun. 2, 2011

Related U.S. Application Data
(60) Provisional application No. 61/351,287, filed on Jun. 3, 2010.
(60) Provisional application No. 61/362,532, filed on Jul. 8, 2010.

(51) Int. Cl. F15D 1/00

(52) U.S. Cl. 137/1; 251/4

(57) ABSTRACT

An apparatus for the emergency capping of pipes and wells is described. The apparatus uses a form of physically deformative valving for emergency closure of pipes and wells. An active magnetic field augmented theta pinch or zeta pinch apparatus causes the pipe or well fixture to collapse or otherwise deform into itself, thus shutting off the flow of material to prevent the environmental damage that may result if the material is a hydrocarbon such as crude oil, natural gas, or the like. The apparatus can be rapidly deployed in response to a situation such as a catastrophic failure of a pipe or well.

### CROSS REFERENCE TO RELATED PATENT APPLICATIONS

This application claims priority to U.S. Patent Application Ser. No. 61/351,287 filed Jun. 3, 2010 entitled “Apparatus For Emergency Electrodynamic Capping Of Pipes And Wells” by Dieter Wolfgang Blum of Aldergrove, British Columbia, Canada. This application also claims priority to U.S. Patent Application Ser. No. 61/362,532 filed Jul. 8, 2010 entitled “Apparatus For Emergency Electrodynamic Capping Of Pipes And Wells With Enhanced Theta Pinch Interaction” by Dieter Wolfgang Blum of Aldergrove, British Columbia, Canada.

### BACKGROUND OF THE INVENTION

1. Field of the Invention

This invention relates generally to pipes and wells, and more particularly to an apparatus for the emergency electrodynamic capping of pipes, wells and related structures.

2. Description of Related Art

There are many occasions where gaseous or liquid wellbores or pipelines are located in extremely haphazard, not easily accessible, or very dangerous environmental locales, for example, on the ocean floor.

In such cases, the occurrence of a wellhead failure, wellbore or pipe leak or breach makes it extremely difficult if not impossible to stem the outflow of contaminant crude oil or natural gas or both, which is a huge negative and catastrophic environmental impact to the earth's fish, wildlife, plants and coastlines.

Previous failure prevention mechanisms and means have relied on physical blockage via mechanical, hydraulic or pneumatic methods in order to prevent or stem leakage. All of these means have proven unreliable at the depths and pressures and other environments wherein they are most relied upon to perform in order to stop catastrophic environmental damage and pollution.

Although the above approaches all rely upon an energy supply such as electricity or mechanical energy (in either case driven by fossil fuel powered prime movers) in order to force closure, intermediate linkage and power delivery complexities are often the main cause of ineffectiveness.

What is desired, are failsafe self-sealing mechanisms of the simplest kind in order to minimize the potential for malfunction.

The present invention and the various embodiments described and envisioned herein comprises a wellbore/pipeline containment/sealing system that overcomes many of the prior art limitations and problems.

It is an object of the present invention to provide for failsafe, predictable and reliable emergency shutoff/closure/flow-stemming valving that is based on electrodynamic principles.

It is another object of the present invention to provide for electrodynamic emergency shutoff valving that can handle either gaseous or liquid feed streams.

It is a further object of the present invention to provide :for cryogenically activated emergency shutoff valving that utilizes the physical solidification of the gaseous or liquid feed stream for valving action.

It is another object of the present invention to provide for electrodynamic emergency shutoff valving that utilizes magnetic theta pinch interaction for rapid valving action and closure.

It is a further object of the present invention to provide for electrodynamic emergency shutoff valving that utilizes magnetic zeta pinch interaction for rapid valving action and closure.

It is another object of the present invention to provide for electrodynamic emergency shutoff valving that utilizes an enhanced and magnetically augmented theta pinch interaction for rapid valving action and closure.

It is another object of the present invention to provide for electrodynamic emergency shutoff valving that utilizes an enhanced and magnetically augmented zeta pinch interaction for rapid valving action and closure.

It is a further object of the present invention to provide for electrodynamic emergency shutoff valving that may be permanently affixed and deployed on wellbores, well pipes or pipelines and the like, or it may be temporarily attached and affixed thereto in times of emergency.

It is another object of the present invention to provide for electrodynamic emergency shutoff valving that utilizes superconducting magnetic field producing means with Low Temperature and High Temperature Superconductors.

It is another object of the present invention to provide for electrodynamic emergency shutoff valving that utilizes pulsed power sources in order to produce large current flow densities (J.) Pulsed power sources include Marx generators, explosively pumped flux compression generators, compulsators and their variants, and superconducting magnetic storage systems. Some of these pulsed power sources can be quite portable and are easily adaptable to provide the necessary high-current impulses for some of the preferred embodiments of the present invention to function as intended. The required and available current densities lie in the range of 10 to 500 mega-amperes, with energy densities in the range of 20 to 1000 mega joules or more (depending on achievable discharge switching speed.)

### BRIEF SUMMARY OF THE INVENTION

In accordance with the present invention, there is provided an apparatus for the emergency capping of pipes and wells comprising an active magnetic field augmented theta pinch or zeta pinch apparatus which causes the pipe or well fixture to collapse or otherwise deform into itself with a rapidly collapsing magnetic field, thus stopping the flow of material to prevent environmental damage that may result if the material is a hydrocarbon such as crude oil, natural gas, or the like.

The foregoing paragraph has been provided by way of introduction, and is not intended to limit the scope of the invention as described by this specification, attached drawings and claims.

### BRIEF DESCRIPTION OF THE DRAWINGS

The invention will be described by reference to the following drawings, in which like numerals refer to like elements, and in which:

FIG. 1 illustrates in schematic cross-section, a passively failsafe electromagnetically actuated poppet form of valving for emergency wellbore/pipe closure, shown in an open flow-through state;

FIG. 2 illustrates in schematic cross-section, the valving of FIG. 1 in a closed flow-stemming state;

FIG. 3 illustrates in schematic cross-section, a passively failsafe electromagnetically actuated butterfly form of valving for emergency wellbore/pipe closure, shown in its open flow-through state;

FIG. 4 illustrates in schematic cross-section, the valving of FIG. 3 shown in its closed flow-stemming state;

FIG. 5 illustrates in schematic cross-section, an active cryogenic form of valving for emergency wellbore/pipe closure, shown in its open flow-through state;

FIG. 6 illustrates in schematic cross-section, the valving of FIG. 5 shown in its closed flow-stemming state;

FIG. 7 illustrates in schematic cross-section, an active electrodynamic theta-pinch form of physically deformative valving for emergency wellbore/pipe closure, shown in its open flow-through state;

FIG. 8 illustrates in schematic cross-section, the valving of FIG. 7 in its closed flow-stemming state;

FIG. 9 illustrates the theta-pinch electrodynamic interactions employed by the valving of FIGS. 7 and 8;

FIG. 10 shows an example of a high-current carrying hollow conductor (pipe) physically deformed by the zeta-pinch electrodynamic interactions;

FIG. 11 illustrates in schematic cross-section, an active magnetic field augmented electrodynamic theta-pinch form of physically deformative valving for emergency wellbore/pipe closure, shown in its open flow-through state;

FIG. 12 illustrates in schematic top view, the valving of FIG. 11:

FIG. 13 illustrates in schematic cross-section, the valving of FIG. 11 shown in its closed flow-stemming state;

FIG. 14 illustrates in schematic cross-section, an active magnetic field augmented electrodynamic zeta-pinch form of physically deformative valving for emergency wellbore/pipe closure, shown in its open flow-through state;

FIG. 15 illustrates in schematic cross-section, the valving of FIG. 14 shown in its closed flow-stemming state;

FIG. 16 illustrates the zeta-pinch electrodynamic interactions employed by the valving of FIGS. 14 and 15.

FIG. 17 illustrates in schematic cross-section, an active hyper-magnetic field theta-pinch form of physically deformative electrodynamic valving for emergency wellbore/pipe closure, showing it in its open now-through state:

FIG. 18 illustrates in schematic top view, the valving of FIG. 17;

FIG. 19 illustrates in schematic cross-section, the valving of FIG. 17 in its closed flow-stemming state;

FIG. 20 shows an example of a current carrying hollow conductor physically deformed by the companion zeta-pinch electrodynamic interaction; and

FIG. 21 is a schematic of a test arrangement for performing zeta pinch experiments.

The present invention will be described in connection with a preferred embodiment, however, it will be understood that there is no intent to limit the invention to the embodiment described. On the contrary, the intent is to cover all alternatives, modifications, and equivalents as may be included within the spirit and scope of the invention as defined by this specification, attached drawings, and claims.

### DESCRIPTION OF THE PREFERRED EMBODIMENTS

For a general understanding of the present invention, reference is made to the drawings. In the drawings, like reference numerals have been used throughout to designate identical elements.

The present invention will be described by way of example, and not limitation. Modifications, improvements and additions to the invention described herein may be determined after reading this specification and viewing the accompanying drawings; such modifications, improvements, and additions being considered included in the spirit and broad scope of the present invention and its various embodiments described or envisioned herein.

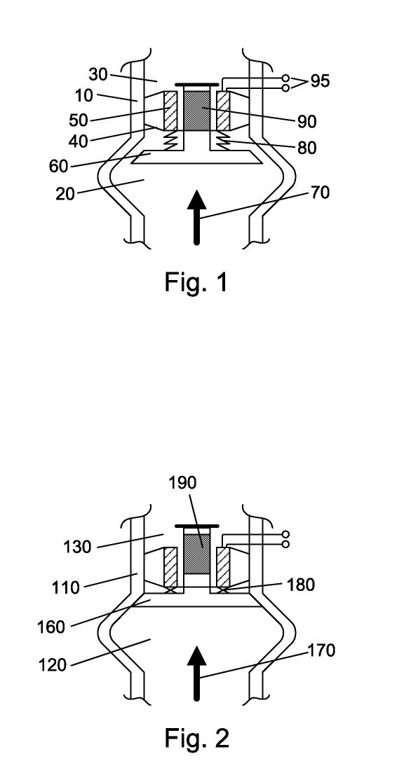

Now there is shown in FIG. 1, in schematic cross-section, an example of a passive failsafe electromagnetically actuated poppet form of valving according to one embodiment of the present invention. It is shown in its normally open flow-through state and will now be described in detail with reference to the various components as depicted in FIG. 1. As shown, a portion of the wellbore/well pipe 10 has a lower entry zone 20 and an upper exit zone 30, where through the feed stream 70 normally passes or is free to flow through. Further shown is a support spider or frame 40, for an electromagnet/solenoid 50, which is placed coaxially within the wellbore or pipe. The electromagnet/solenoid may be conventional or superconducting in construction. A poppet valve 60 having a highly magnetically permeable stem 90, is also placed coaxial to both the electromagnet/solenoid. Also shown are expansion springs 80 which serve to reduce the amount of energy needed to create an appropriate magnetic field by the electromagnet/solenoid, as will now be explained.

The feed stream 70, whether gaseous or liquid, will normally exert a force on the bottom of the poppet valve (similar to a piston) providing a tendency for the feed stream to force the poppet valve into it's closed off position. However, the expansion springs provide an opposing force in the range of 25 to 75% of the force on the poppet valve face by the feed stream. The electromagnet/solenoid, when energized at terminals 95, provides a magnetic reluctance force on the valve stem (due to maximizing magnetic flux interlinkage) that in turn is transferred to the poppet valve. The magnetic reluctance force is equal to 50 to 200% of the force on the poppet valve face by the feed stream.

In this fashion, it can be seen that the combination of forces from the expansion springs and the electromagnet/solenoid onto the poppet valve, serves to overcome the force on the poppet valve face by the feed stream, and therefore causes the poppet valve to be in its open or flow-through position as is shown here.

Shown in FIG. 2, in schematic cross-section, is the valving of FIG. 1, but now in its closed flow-stemming state. Shown are the wellbore/well pipe 110, the lower entry zone 120, is the upper exit zone 130, the feed stream 170 and the poppet valve 160 and its valve stem 190. As shown, it can be seen that the valve is now seated and in it's closed off position. This is because there is no magnetic field interacting with the valve stem portion 190, and hence, the force provided by the expansion springs 180 is less than the force on the poppet valve face exerted by the feed stream. As shown here, the expansion springs are now compressed.

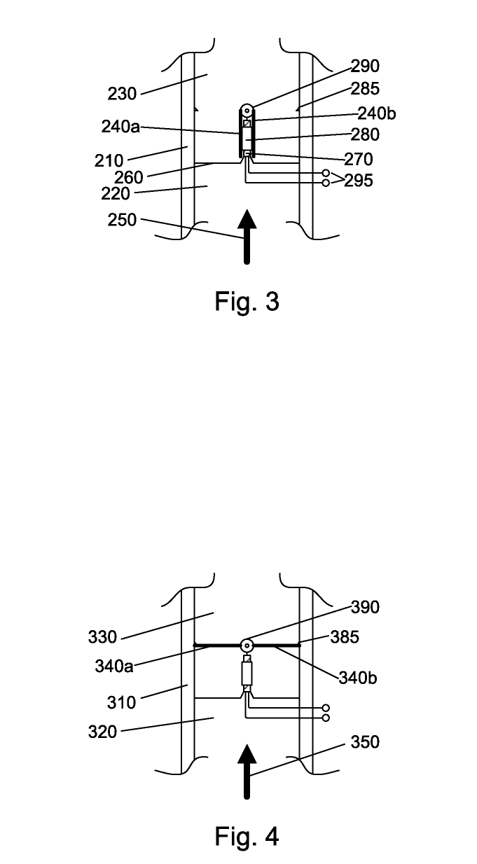

Now there is shown in FIG. 3, in schematic cross-section, an example of a passively failsafe electromagnetically actuated butterfly form of valving according to another embodiment of the present invention. It is shown in its normally open flow-through state and will now be described in detail with reference to the various components as depicted in FIG. 3. As shown, a portion of the wellbore/well pipe 210 has a lower entry zone 220 and an upper exit zone 230, where through the feed stream 250 normally passes or is free to flow through. Further shown is a support spider or frame 260, for an electromagnet 270, which is placed coaxially within the wellbore or pipe. The electromagnet may be conventional or superconducting in construction and has a permeable core 280. Further shown are two butterfly valve wings 240a and 240b suspended from swivel point 290. The butterfly valving wings are comprised of magnetically permeable material such as steel. Also visible are butterfly valving wing stops 285 disposed within the wellbore/well pipe interior.

The feed stream 250, whether gaseous or liquid, will normally exert a force on the bottoms of the butterfly valving wings, providing a tendency for the feed stream to force the butterfly wings up and onto their stops, and therefore into their closed off position.

However, the electromagnet when energized at terminals 295, provides a magnetic attractive force on the butterfly valving wings in order to keep them folded open. The magnetic attractive force is equal to 50 to 200% of the force on the butterfly valving wings by the feed stream.

In this fashion, it can be seen that the force from the electromagnet onto the butterfly valving wings, serves to overcome the force on the butterfly valving wings by the feed stream, and therefore causes the butterfly valve remain in its open or flow-through position as is shown.

Shown in FIG. 4, in schematic cross-section, is the valving of FIG. 3, but now in its closed flow-stemming state. Shown are the wellbore/well pipe 310, the lower entry zone 320, the upper exit zone 330, the feed stream 350 and the butterfly valving wings 340a and 340b suspended from swivel point 390.

As shown, it can be seen that the butterfly valving wings are now seated against their stops 385 and are in their closed off position. This is because there is no magnetic field interacting with the butterfly valving wings and maintaining them in their open position.

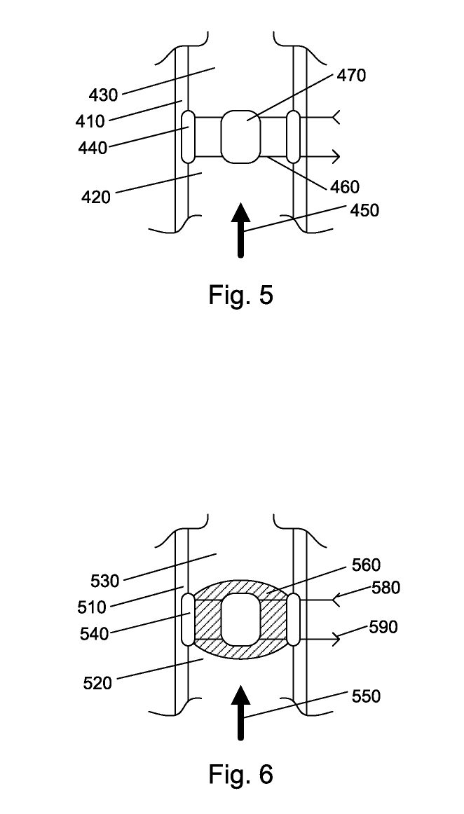

Now shown in FIG. 5, in schematic cross-section, is an example of an active cryogenic form of valving according to another embodiment of the present invention. It is shown in its normally open flow-through state and will now he described in detail with reference to the various components as depicted in FIG. 5. As shown, a portion of the wellbore/well pipe 410 has a lower entry zone 420 and an upper exit zone 430, where through the feed stream 450 normally passes or is free to flow through. Further shown is a support spider or frame 460, with internal cryogenic fluid ducting, for a heat exchanger 470, which is placed coaxially within the wellbore or pipe. Wellbore/well pipe wall mounted heat exchangers 440 are also shown connected to the same cryogenic fluid ducting. The number of the heat exchangers 440 is determined by the rate of valving desired. As illustrated, the feed stream 450, whether gaseous or liquid, is free to flow past and through the cryogenic valving, as the cryogenic valving will be above the phase change point of the feed stream. Examples include, but are not limited to methane@91° K, liquid Nitrogen @77° K.

Now shown in FIG. 6, in schematic cross-section, is the valving of FIG. 5, but now in its closed flow-stemming state. Shown are the wellbore/well pipe 510, the lower entry zone 520, the upper exit zone 530, the feed stream 550 and the heat exchangers 540. The admission and flow of cryogenic fluid through fluid ports 580 and 590 will affect a rapid cooling and continual solidification of the feed stream on and around the heat exchanger structure. As shown, it can be seen that a solidified feed stream mass 560 has formed in the interior of the wellbore/well pipe 510, thereby causing the cryogenic valving to be in its closed off state.

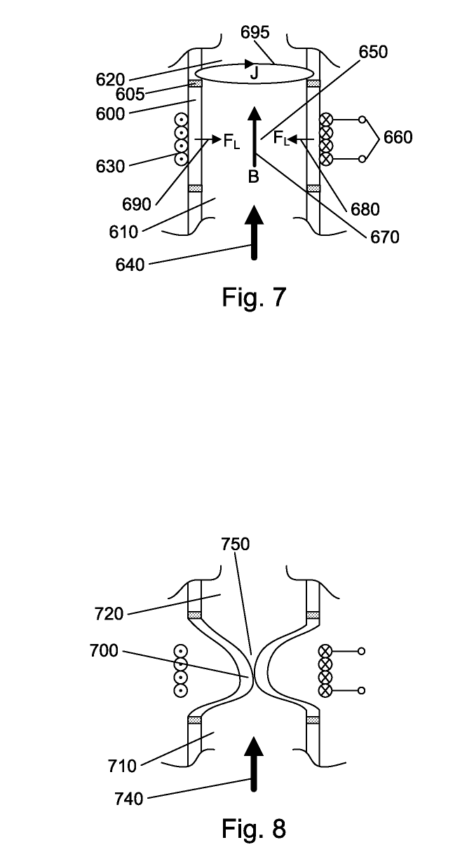

Shown in FIG. 7, in schematic cross-section, is an example of an active electrodynamic theta-pinch form of physically deformative valving according to another embodiment of the present invention. It is shown in its normally open flow-through state and will now be described in detail with reference to the various components as depicted in FIG. 7. As shown, a section of the wellbore/well pipe 600 has a lower entry zone 610 and an upper exit zone 620, where through the feed stream 640 normally passes or is free to flow through. The section of pipe has a first end and a second end and has an interior wall and an exterior wall. Further shown are dielectric spacers 605 (although not completely necessary, they can limit current dissipation.) Also shown is a conductive winding 630 circumferentially placed about the exterior wall of the wellbore/well pipe section. When a high-current impulse/discharge is sent through winding 630 via connections 660 using a high current high voltage source, there is generated an axial magnetic flux field B 670, which in turn induces a large electrical current (density J) 695 to flow circumferentially in the wellbore/well pipe casing. The interaction of the self magnetic field due to the current flow and the current flow charges themselves (electrons) will exert Lorentz forces 680 and 690 within the interior of the wellbore/well pipe casing, and these forces will he directed inward as shown towards the constriction or θ-pinch zone 650.

As illustrated, the feed stream 640, whether gaseous or liquid, is free to flow past and through the electrodynamic theta-pinch form of physically deformative valving until such time as a large current impulse/discharge is sent through the winding. When the event occurs, there will be massive forces deforming and pinching the wellbore/well pipe casing, in essence pinching it shut, as will be described below.

Now shown in FIG. 8, in schematic cross-section, is the valving of FIG. 7, but now in its closed flow-stemming state. Shown are the wellbore/well pipe 700, the lower entry zone 710, the upper exit zone 720, and the feed stream 740. As illustrated, in/at the θ-pinch or constriction zone 750, the wellbore/well pipe walls have collapsed inward, thereby causing the electrodynamic theta-pinch form of physically deformative valving to be in its closed off state.

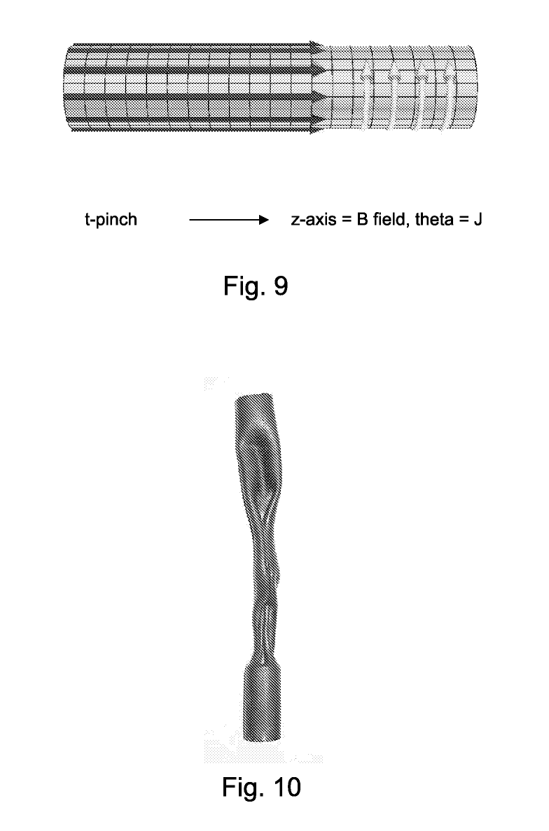

Now shown in FIG. 9, there is illustrated the theta-pinch interactions employed by the active electrodynamic θ-pinch form of physically deformative valving described in FIGS. 7 and 8.

In FIG. 10 there is shown an example of a high-current carrying hollow conductor (pipe) physically deformed by the θ-pinch electrodynamic interactions employed by the active electrodynamic θ-pinch form of physically deformative valving described in FIGS. 7 and 8.

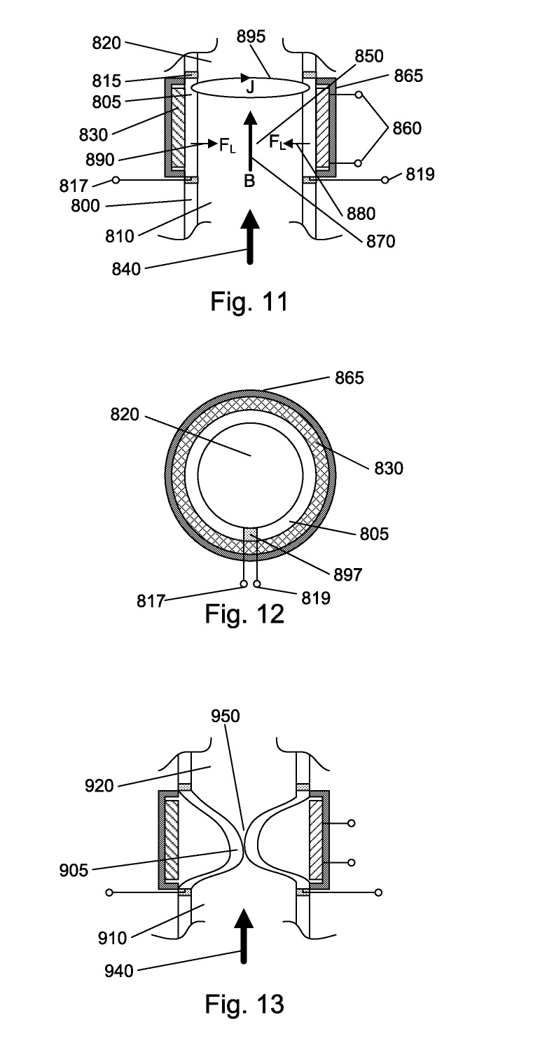

Now shown in FIG. 11, in schematic cross-section, is an example of an active magnetic field augmented electrodynamic theta-pinch form of physically deformative valving according to another embodiment of the present invention. It is shown in its normally open flow-through state and will now be described in detail with reference to the various components as depicted in FIG. 11. As shown, a section of the wellbore/well pipe 800 has a lower entry zone 810 and an upper exit zone 820, where through the feed stream 840 normally passes or is free to flow through. The section of pipe has a first end and a second end and has an interior wall and an exterior wall. Further shown are dielectric spacers 815, which serve to constrain injected current flow to a particular longitudinal section 805 of the wellbore/well pipe. Also shown is a conductive winding 830 circumferentially placed about the exterior wall of the wellbore/well pipe section, which may be of conventional or superconducting construction. The winding 830 may be energized via terminals 860 using a high current high voltage source when necessary, and when so energized, there is generated an axial magnetic flux field B 870. Also shown (in order to increase flux density) is magnetic back iron 865 on the outside of the winding.

Terminals 817 and 819 serve to inject a large electrical current (density J) 895 (large current impulse preferably, as would be used in a normal externally induced θ-pinch) to flow circumferentially in the wellbore/well pipe casing portion 805 using a suitable high current high voltage source. The interaction of winding generated magnetic field and the current flow charges (electrons) will exert Lorentz forces 880 and 890 within the interior of the wellbore/well pipe casing portion 805, and these forces will be directed inward as shown towards the constriction or θ-pinch zone 850.

As illustrated, the feed stream 840, whether gaseous or liquid, is free to flow past and through the magnetic field augmented electrodynamic theta-pinch form of physically deformative valving until such time as both a large axial magnetic field is set up by the solenoidal winding 830, and a large current impulse/discharge is sent through the wellbore/well pipe casing portion 805. When these two events occur in proper relationship, there will be massive Lorentz forces deforming and pinching the wellbore/well pipe casing portion 805, pinching it shut. It should be noted, that this method does not rely on the conventional method of induced currents and their attendant magnetic fields.

Now shown in FIG. 12, in schematic top view, is the valving of FIG. 11. Shown are the wellbore/well pipe casing 805, the solenoidal winding 830, the winding back-iron 865 and the interior flow area (exit portion) 820. Also shown is a further longitudinal dielectric segment 897 displaced in the circumference of the casing 805 and the current injection terminals 817 and 819. It can be seen that any injected current will flow circumferentially in the wellbore/well pipe casing portion 805.

Now shown in FIG. 13, in schematic cross-section, is the valving of FIG. 11, but now in its closed flow-stemming state. Shown are the wellbore/well pipe 905, the lower entry zone 910, the upper exit zone 920, and the feed stream 940. As illustrated, in/at the θ-pinch or constriction zone 950, the wellbore/well pipe walls 905 have collapsed inward, thereby causing the magnetic field augmented electrodynamic theta-pinch form of physically deformative valving to be in its closed off state.

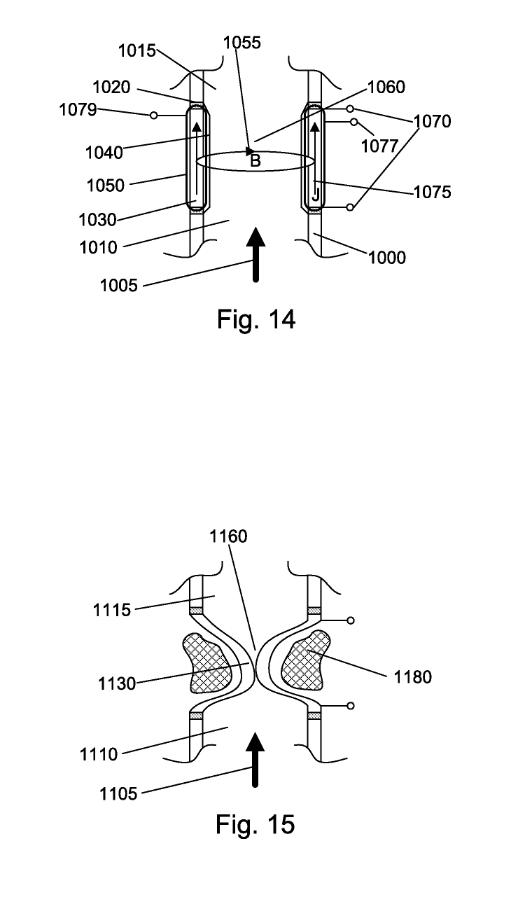

Shown in FIG. 14, in schematic cross-section, is an example of an active magnetic field augmented electrodynamic zeta-pinch form of physically deformative valving according to another embodiment of the present invention. It is shown in its normally open flow-through state and will now be described in detail with reference to the various components as depicted in FIG. 14. As shown, a section of the wellbore/well pipe 1030 has a lower entry zone 1010 and an upper exit zone 1015, where through the feed stream 1005 normally passes or is free to flow through. The section of pipe has a first end and a second end and has an interior wall and an exterior wall. Further shown are dielectric spacers 1020, which serve to constrain injected current flow to a particular longitudinal section 1030 of the wellbore/well pipe. Also shown is a conductive winding 1050 circumferentially placed about the interior and exterior walls of the wellbore/well pipe section 1030, which may be of conventional or superconducting construction. The winding 1050 has an armored or protective cover 1040 in the interior of the wellbore/well pipe for its protection. The winding 1050 may be energized via terminals 1077 and 1079 using a high current high voltage source when necessary, and when so energized, there is generated a radial magnetic flux field B 1055 within the wellbore/well pipe casing portion 1030.

Terminals 1070 serve to inject a large electrical current (density J) 1075 (large current impulse preferably, as would be used in a normal externally induced zeta- or θ-pinch) to flow longitudinally in the wellbore/well pipe casing portion 1030. The interaction of winding generated magnetic field and the current flow charges (electrons) will exert Lorentz forces (not shown) similar to those previously described in relation to θ-pinch, within the interior of the wellbore/well pipe casing portion 1030, and these forces will be directed inward as depicted, toward the constriction or zeta-pinch zone 1060.

As illustrated, the feed stream 1005, whether gaseous or liquid, is free to flow past and through the magnetic field augmented electrodynamic zeta-pinch form of physically deformative valving until such time as both a large radial magnetic field is set up by the solenoidal winding 1050, and a large current impulse/discharge is sent through the wellbore/well pipe casing portion 1030. When these two the events occur in proper relationship, there will he massive Lorentz forces deforming and pinching the wellbore/well pipe casing portion 1030, pinching it shut. It should be noted, that this method also does not rely on the conventional method of induced currents and their attendant magnetic fields.

FIG. 15 illustrates in schematic cross-section, the valving of FIG. 14 in its closed flow-stemming state;

Now shown in FIG. 15, in schematic cross-section, is the valving of FIG. 14, but now in its closed flow-stemming state. Shown are the wellbore/well pipe 1130, the lower entry zone 1110, the upper exit zone 1115, and the feed stream 1105. As illustrated, in/at the zeta-pinch or constriction zone 1160, the wellbore/well pipe walls 1130 have collapsed inward, thereby causing the magnetic field augmented electrodynamic zeta-pinch form of physically deformative valving to be in its closed off state. As this form of valving employs a sacrificial winding (i.e., it is destroyed during valving actuation), the remnants thereof are depicted by mass slugs 1180.

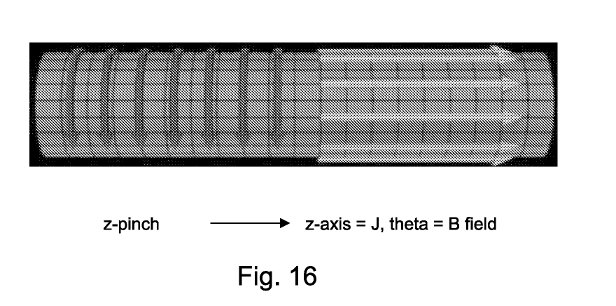

Now shown in FIG. 16, there is illustrated the zeta-pinch interactions employed by the active electrodynamic zeta-pinch form of physically deformative valving described in FIGS. 14 and 15.

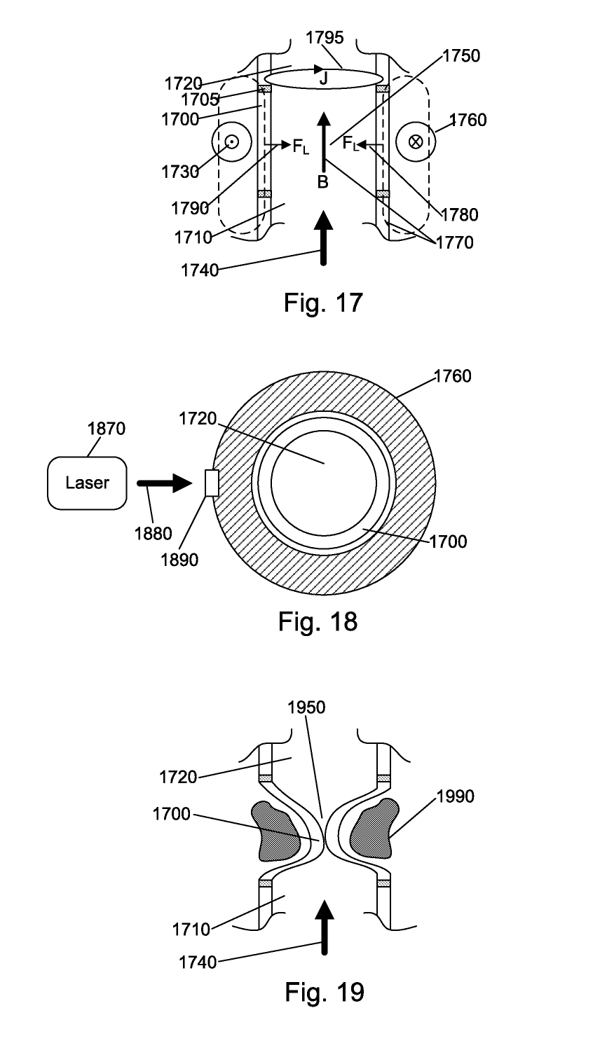

Now there is shown in FIG. 17, in schematic cross-section, an example of an active theta-pinch form of physically deformative electrodynamic valving according to one preferred embodiment of the present invention. The electrodynamic valving of the present invention is illustratively shown in its normally open flow-through state and will now be described in detail with reference to the various components depicted in FIG. 17. As shown, a section of the wellbore/well pipe 1700 has a lower entry zone 1710 and an upper exit zone 1720, where a feed stream 1740 normally passes or is free to flow through. A feed stream 1740 may be, by example and not limitation, a hydrocarbon material such as crude oil, natural gas, and the like. The section of pipe has a first end and a second end and has an interior wall and an exterior wall. Further shown are dielectric spacers 1705 (although not completely necessary, they can limit current dissipation.) Also shown is a single-turn toroidal current-carrying loop/conductive winding 1730 circumferentially placed about the exterior wall of the wellbore/well pipe section 1700. In some embodiments of the present invention, multiple turns may be present.

The winding 1730 is preferentially superconducting, the winding 1730 being suitably energized with a high current high voltage source to have a high-current density azimuthal/circumferential flow of electric current therein. The winding 1730, may be enclosed in a suitable cryostat 1760 constructed of a material that is electrically non-conducting. Cryostats are known and are important for the application of materials such as superconducting materials. A cryostat is essentially a low temperature refrigerator used to cool, for example, infrared detectors, medical instruments, and superconducting devices. Cryostats are known to those skilled in the art. Examples of cryostats are those made by Janis Research (www.janis.com), Shi Cryogenics (shicryogenics.com), and Ball Aerospace (www.ballaerospace.com). The winding 1730 will generate an axial static magnetic flux field (B) 1770, one portion thereof being mostly concentrated within the volume of the wall of the wellbore/well pipe 1700 due to, in the case of steel or iron pipe, the much higher magnetic IS permeability of the wall; although the present invention may also be used with non-ferromagnetic pipe materials.

The winding 1730 is designed and constructed so as to be physically open-circuited (by means that by example arc described hereinafter) in a very rapid manner such that no arcing at the coil opening occurs, thereby causing a very rapid collapse of the magnetic field 1770.

This rapid collapse of the magnetic field 1770 induces a large electrical current (density J) 1795 to flow azimuthally/circumferentially in the wellbore/well pipe casing. The interaction of the self magnetic field due to the current flow 1795 (this B field is again axial) and the charges contained in the current flow (electrons) will exert Lorentz forces 1780 and 1790 within the interior of the wellbore/well pipe casing, and these forces will be directed inward as shown towards the constriction or θ-pinch zone 1750.

Unlike the well-known magneforming technique for the magnetic deformation of metal, wherein there is utilized the discharge of an energy source such as a Marx capacitor bank or the like, into a work coil, and wherein the maximum magnetic pressure within the work material is observed within the first quarter to one-half cycle of a decaying or ringing oscillatory discharge, the present invention and the various embodiments described and envisioned herein, transfers all of the energy stored in the magnetic field 1770, due to the large circulating current in the winding 1730, to the “work piece”, for example the wellbore/well pipe 1700, in a singular, almost instantaneous manner, without insignificant ringing or oscillatory behavior. This fact, along with the inherent pre-magnetization of the pipe wall material (in the case of ferromagnetic materials) realizes far greater magnetic pressures and deformation forces than were heretofore possible.

As illustrated, the feed stream 1740, whether gaseous or liquid, is free to flow past and through the electrodynamic theta-pinch form of physically deformative valving until such time as the large circulating current in the winding 1730 is quickly interrupted. When this event occurs, there will he massive forces deforming and pinching the wellbore/well pipe casing, in fact pinching it shut, as will be further described below. In the above description, electrical current introduction means and cryogenic cooling means are not shown for simplicity, as they are well known in the art.

Now shown in FIG. 18, in schematic top view, is the electrodynamic valving of FIG. 17. Shown in schematic top view is the wellbore/well pipe 1700, the cryostat 1760 containing the solenoidal winding and the interior flow area (upper exit zone) 1720. Also shown are a high-power (pulsed) laser 1870, its photon/radiation emission flux beam 1880, and an optical input aperture 1890 optimally disposed on the cryostat housing 1760 to admit said flux beam 1880 into the interior of the cryostat 1760.

When the laser 1870 is energized and its emission flux beam 1880 is admitted into the interior of the cryostat 1760, and incident on the superconducting winding with power levels appropriate to not only effect a very rapid transition past T_{C} (Critical Temperature) of a portion of the superconducting coil, but to also cause physical disruption of a portion of said coil, in both cases due to the absorption of a large amount of energy from the flux beam, the flow of current in the coil is effectively open-circuited very rapidly, leading to the rapid collapse of the magnetic field previously established by the large circulating current in said winding.

Although coil disruption has been heretofore described by utilizing energetic photonic flux from a laser, other disruptive means such as controlled explosives, high-speed mechanical means (i.e., pneumatic), magnetic means (transition past H_{C}), and the like, may be used to disrupt the coil. Fast coil disruption being necessary to quickly open circuit the coil and cause a rapid collapse of the associated magnetic field, thus resulting in theta pinch of the wellbore/wellpipe 1700.

Now shown in FIG. 19, in schematic cross-section, is the electrodynamic valving of FIG. 17, but now in its closed flow-stemming state. Shown are the wellbore/well pipe 1700, the lower entry zone 1710, the upper exit zone 1720, and the feed stream 1740. As illustrated, in/at the θ-pinch or constriction zone 1950, said wellbore/well pipe walls 1700 have collapsed inward, thereby resulting in a magnetic field augmented electrodynamic theta-pinch form of physically deformative valving to be in its closed off state. Exterior remnants 1990 of the coil containing cryostat are also shown for illustrative purposes only.

Referring back to FIG. 9, the theta-pinch interactions employed by the active hyper-magnetic field θ-pinch form of physically deformative electrodynamic valving described in FIGS. 17, 18 and 19 can be seen.

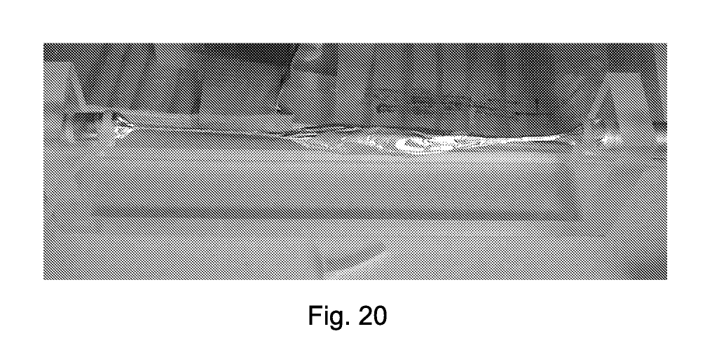

FIG. 20 is an example of a current carrying hollow conductor physically deformed by the companion zeta pinch electrodynamic interactions of the present invention and the various embodiments described and envisioned herein. The example depicted in FIG. 20 is representative of the electrodynamic interactions that are possible with applicants valving mechanisms that incorporate theta pinch, zeta pinch, and combinations and variations thereof.

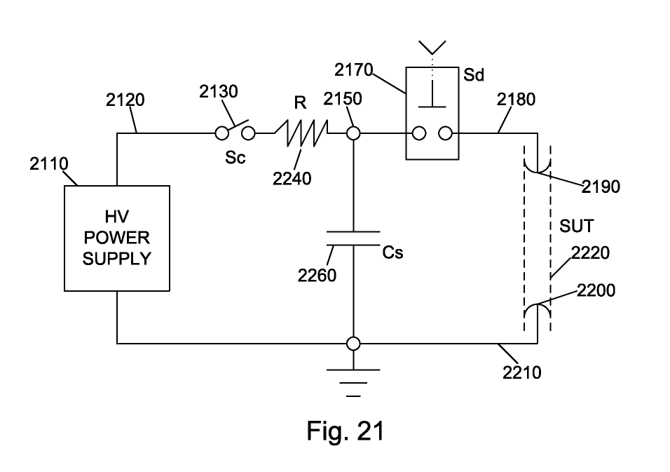

To further aid in understanding the present invention and the various embodiments of the present invention, and to allow the reader the opportunity to envision further embodiments of the present invention, FIG. 21 depicts in schematic form a test arrangement for performing zeta pinch experiments and evaluating various material samples under test.

Depicted in FIG. 21 is high-voltage power supply 2110, capable of providing appropriate potential (25 kV to 150 kV) at sufficient power levels to charge storage capacitor 2160 within a reasonable time period. It can be seen that the output 2120 from said supply 2110 is connected to charging switch 2130, which in turn is connected via limiting resistor 2140 to node 2150. When said switch 2130 is closed, it is evident that storage capacitor 2160 will be charged up to the potential provided by said power supply 2110 over a time interval, since the other terminal of said capacitor 2160 is connected to the ground/return line 2210.

The sample under test (sun 2220, which for example may be a tubular length of conductive material (i.e., aluminum, copper, brass, iron, steel etc.) is clamped between the upper electrode 2190 and lower electrode 2200. Said electrodes may be comprised of copper or the like. Said lower electrode 2200 is connected to said return line 2210, and said upper electrode is connected via line 2180 to discharge switch 2170. Said switch 2170 may be of the air arc, oil immersion or vacuum type (armor enclosed/explosion proof) and serves to close the circuit in order to discharge the storage capacitor 2160 through the sample under test 2220. Said discharge switch 2170 must be capable of providing the appropriate standoff to the potential to which the capacitor 2160 is charged, and it must be capable of being closed very rapidly to minimize arcing energy loss, as well it must be safely and remotely triggered, and it must be capable of handling the large discharge currents (10 kA to 10MA or more) that occur during the zeta pinch experiment. In some embodiments of the present invention, said switch 2170 may also be of the one-shot type, for example, sacrificial.

In use, the apparatus for emergency electrodynamic capping of pipes and wells may be placed about a section of pipe during various situations, such as during installation of the pipe, during a disaster situation, or in a controlled factory setting. For example, the apparatus may be constructed as a section of pipe with the various required components, and shipped to a job location as a component to he installed, similar to the way a valve is installed and fit into a pipe assembly. The steps to be taken to cap a pipe or well using the present invention involve placing a conductive winding circumferentially about a section of pipe, electrically coupling a high current high voltage source to the conductive winding, creating a magnetic Field about the conductive winding, causing a current to flow in the section of pipe, decoupling the high current high voltage source from the conductive winding, rapidly collapsing the magnetic field, and collapsing inward the section of pipe. The result being a pinched off pipe section that does not accommodate flow of material.

It is, therefore, apparent that there has been provided, in accordance with the various objects of the present invention, an apparatus for the emergency capping of pipes, wells, and the like. While the various objects of this invention have been described in conjunction with preferred embodiments thereof, it is evident that many alternatives, modifications, and variations will be apparent to those skilled in the art. Accordingly, it is intended to embrace all such alternatives, modifications and variations that fall within the spirit and broad scope of the present invention as defined by this specification, attached drawings and claims.

What is claimed is:

1. An apparatus for active electrodynamic physically deformative capping of pipes and wells, the apparatus comprising:
a section of pipe having a first end and a second end and having an interior wall and an exterior wall;
a first dielectric spacer placed at the first end of the section of pipe to constrain injected current flow to the section of pipe;
a conductive winding circumferentially placed about the exterior wall of the pipe section; and
a high current high voltage source electrically coupled to the conductive winding for creating a current impulse.

2. The apparatus for active electrodynamic physically deformative capping of pipes and wells as recited in claim 1, further comprising a second dielectric spacer placed at the second end of the section of pipe to constrain injected current flow to the section of pipe.

3. The apparatus for active electrodynamic physically deformative capping of pipes and wells as recited in claim 1, further comprising a first current injection terminal and a second current injection terminal electrically coupled to the section of pipe.

4. The apparatus for active electrodynamic physically deformative capping of pipes and wells as recited in claim 3, further comprising a current impulse source electrically coupled to the first current injection terminal and the second current injection terminal.

5. The apparatus for active electrodynamic physically deformative capping of pipes and wells as recited in claim 1, further comprising a magnetic back iron placed about the conductive winding.

6. The apparatus for active electrodynamic physically deformative capping of pipes and wells as recited in claim 1, further comprising a discharge switch.

7. The apparatus for active electrodynamic physically deformative capping of pipes and wells as recited in claim 6, wherein said discharge switch is remotely triggered.

8. The apparatus for active electrodynamic physically deformative capping of pipes and wells as recited in claim 6, wherein said discharge switch is sacrificial.

9. The apparatus for active electrodynamic physically deformative capping of pipes and wells as recited in claim 1, further comprising a second conductive winding circumferentially placed about the interior wall of the pipe section.

10. The apparatus for active electrodynamic physically deformative capping of pipes and wells as recited in claim 9, further comprising a protective covering for the second conductive winding.

11. The apparatus for active electrodynamic physically deformative capping of pipes and wells as recited in claim 1, further comprising a storage capacitor electrically connected in parallel with said high current high voltage source.

12. An apparatus for active electrodynamic physically deformative capping of pipes and wells, the apparatus comprising:
a section of pipe having a first end and a second end and having an interior wall and an exterior wall;
a superconductive winding circumferentially placed about the exterior wall of the pipe section;
a cryostat with cooling output directed at the superconductive winding;
a high current high voltage source electrically coupled to the superconductive winding for creating a current impulse; and
a coil disruption device placed in electrical series connection with said superconductive winding.

13. The apparatus for active electrodynamic physically deformative capping of pipes and wells as recited in claim 12, further comprising a first dielectric spacer placed at the first end of the section of pipe to constrain injected current flow to the section of pipe.

14. The apparatus for active electrodynamic physically deformative capping of pipes and wells as recited in claim 13, further comprising a second dielectric spacer placed at the second end of the section of pipe to constrain injected current flow to the section of pipe.

15. The apparatus for active electrodynamic physically deformative capping of pipes and wells as recited in claim 12, wherein said coil disruption device is a high-power laser.

16. The apparatus for active electrodynamic physically deformative capping of pipes and wells as recited in claim 12, wherein said coil disruption device is an explosive device.

17. The apparatus for active electrodynamic physically deformative capping of pipes and wells as recited in claim 12, wherein said coil disruption device is a pneumatic device.

18. The apparatus for active electrodynamic physically deformative capping of pipes and wells as recited in claim 12, wherein said coil disruption device is a magnetic device.

19. A method for capping pipes and wells, the method comprising the steps of:
placing a conductive winding circumferentially about a section of pipe;
electrically coupling a high current high voltage source to the conductive winding;
creating a magnetic field about the conductive winding;
causing a current to flow in the section of pipe;
decoupling the high current high voltage source from the conductive winding;
rapidly collapsing the magnetic field; and
collapsing inward the section of pipe.

20. The method for capping pipes and wells as recited in claim 19, wherein the conductive winding is superconductive.
